(19) United States
(12) Patent Application Publication
(10) Pub. No.: US 2011/0205156 A1
(43) Pub. Date: Aug. 25, 2011

(54) COMMAND BY GESTURE INTERFACE

(75) Inventors: David Gomez, Gernoble (FR); Cyrille Soubeyrat, Reaumont (FR); Yanis Caritu, Saint Joseph de Riviere (FR)

(73) Assignee: MOVEA S.A, Grenoble Cedex 9 (FR)

(21) Appl. No.: 13/120,955

(22) PCT Filed: Sep. 25, 2009
(86) PCT No.: PCT/EP2009/062420

§ 371 Date: May 12, 2011

Related U.S. Application Data
(60) Provisional application No. 61/100,254, filed on Sep. 25, 2008.

(51) Int. Cl. G06F 3/033; G06F 3/01

(52) U.S. Cl. 345/157; 345/156

(57) ABSTRACT

The invention discloses a device and a method for commanding appliances by a gesture. User interfaces of the prior art have the limitation that they require an increasing number of buttons and/or graphical input areas on a display, so that the learning time of the user increases exponentially and his ability to memorise the corresponding codes decreases inversely. The device of the invention, in various embodiments which may be combined, increases the number of functions of one or more appliances which may be controlled without increasing the number of buttons and/or graphical control zones of displays. This is provided by including an orientation sensor in the device, said orientation being one of the parameters to control the operating mode of the device.

This application is a national phase application under §371 of PCT/EP2009/062420, filed Sep. 25, 2009, which claims priority to U.S. Provisional Patent Application No. 61/100,254, filed Sep. 25, 2008, the entire content of which is expressly incorporated herein by reference.

The present invention deals with man machine interface capable of sending commands to electronic devices. More specifically, it applies to motion capture devices used for recognizing gestures used as a command code for said electronic devices, alone or in combination with other command interface such as buttons, scrolls, joysticks or the like. This type of interface is especially useful with computers, TVs or home theatres, audio equipment and game consoles. It can also be used to control any kind of electric equipment in a house or an office, such as a coffee machine, a washing machine, a refrigerator, a microwave oven, lights, heating or air conditioning, etc . . . Since one may have to control a plurality of devices in a plurality of states, it becomes necessary to increase significantly the number of hardware-represented states (for instance have tens of buttons on a remote control) or the number of software-represented states (for instance have tens of icons on the office screen of a PC). In both implementations, the interface may become complex to operate and not at all intuitive.

These user interfaces of the prior art have the limitation that they require an increasing number of buttons and/or graphical input areas on a display, so that the learning time of the user increases exponentially and his ability to memorise the corresponding codes decreases inversely.

The present invention solves this problem by providing a third dimension of states representation and control by human gesture in addition to those by hardware and software.

The device of the invention, in various embodiments which may be combined, increases the number of functions of one or more appliances which may be controlled without increasing the number of buttons and/or graphical control zones of displays. This is provided by including an orientation sensor in the device, said orientation being one of the parameters to control the operating mode of the device.

To this effect, the invention discloses a device for control by a user of at least one appliance comprising at least a sensor for capturing at least an orientation of said device, an interface to a processor, a mode selector for the user to select operating modes of one of said device and said appliance, an interface to at least a communication link to convey command signals to said appliance, said device being characterised in that said processor converts said orientation into a first set of command signals representative of one of a first set of operating modes of one of said device and said appliance and said user is offered a selection among a second set of operating modes depending upon said one of said first set of operating modes, said selection generating a second set of command signals.

Advantageously, the device of the invention comprises a module to point at a designated appliance and direct said command signals at said designated appliance.
Advantageously, the pointing device points at a designated area on said designated appliance, said area comprising commands to be executed as a function of the command signals received from said device.
Advantageously, the device of the invention comprises a module to capture beats and/or snaps from the user and generate an output to be combined with the first and second set of command signals.
Advantageously, the device of the invention comprises a module to capture gestures from the user and generate an output to be combined with the first and second set of command signals.
Advantageously, the first set of command signals defines n modes, each of the n modes having a number of sub modes which are controlled by the second set of command signals.
Advantageously, one of yaw, pitch and roll of the device is classified into n discrete modes and the mode selector is made of p buttons, said device being then capable of controlling n x p modes of one or more appliances.
Advantageously, a first subset of the first set of command signals corresponding to one of roll, pitch and yaw of the device and defines q modes, and a second subset of said first set of command signals corresponding to an other of roll, pitch and yaw of the device defines a value of each mode q.

Advantageously, the output of the orientation sensor defines an operating mode of the device.

Advantageously, the operating modes of the device comprise at least a gesture recognition mode, a pointing mode and a scroll mode.
Advantageously, the mode selector activates/deactivates a keyboard and the orientation sensor is worn on one wrist of one hand of the user.
Advantageously, the pointing function of the orientation sensor is deactivated as long as the hand of the user wearing said sensor stays in a first orientation fit for typing on the keyboard and is activated as long as said hand stays in a second orientation different from the first orientation.

The invention also discloses a system for control by a user of at least one appliance comprising at least a first device and at least a second device according of the invention, wherein said first device defines a number of first options for controlling said appliance and said second device defines a second number of second options as sub options of the first options.

The invention also discloses a method for control by a user of at least one appliance comprising at least a step for capturing by a motion sensor encased in a device borne by said user at least an orientation of said device, a step of interface to a processor, a step of using a mode selector for the user to select operating modes of one of said device and said appliance, a step of interface to at least a communication link to convey command signals to said appliance, said method being characterised in that said processor converts said orientation into a first set of command signals representative of one of a first set of operating modes of one of said device and said appliance and said user is offered a selection among a second set of operating modes depending upon said one of said first set of operating modes, said selection generating a second set of command signals.

Advantageously, the method of the invention comprises a step of capturing orientation of a second device, said orientation of a second device being combined with said second set of command signals to generate a third set of command signals.

The device of the invention makes use of MEMS which are becoming cheaper and cheaper and is thus not costly to produce. The device can be of small dimensions and weight. Also, its software is easy to customise or maintain, for instance by providing applets to the user. Thus the user can get access to new programmes for controlling new appliances or implementing new modalities for controlling old appliances. Another advantage is that the command gestures can be chosen as simple and as discriminatory as possible, so that the user may intuitively use the device and the method of the invention.

The invention will be better understood and its various features and advantages will become apparent from the description of various embodiments and of the following appended figures:

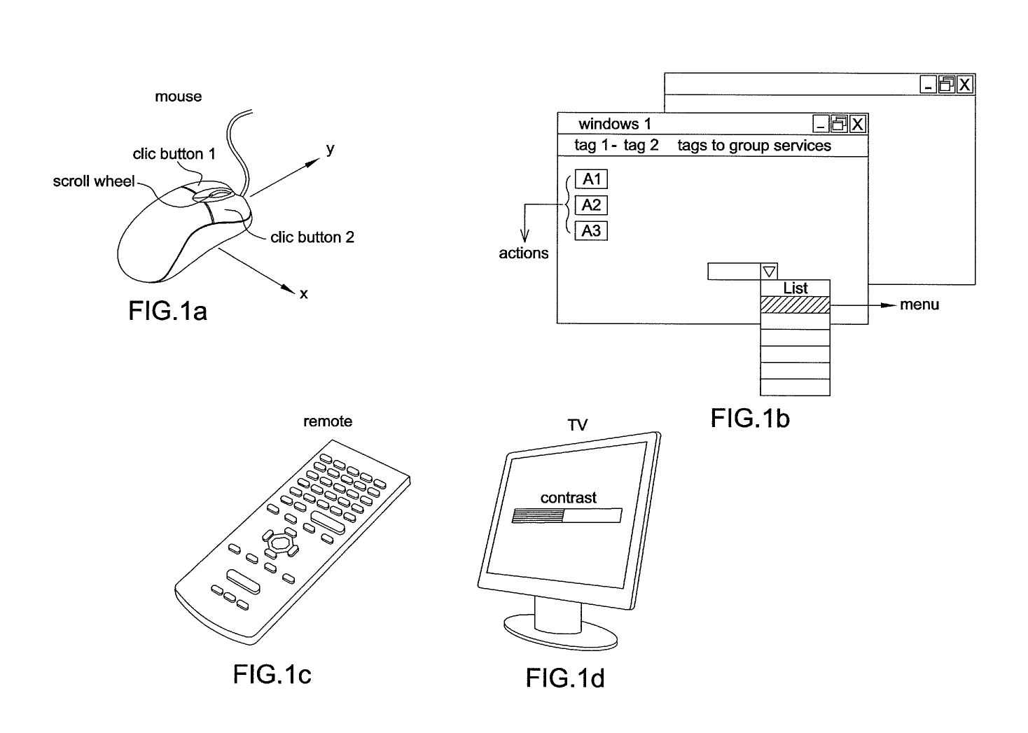

FIG. 1a through 1d represent some interface devices of the prior art and the principle of mapping devices events to actions;

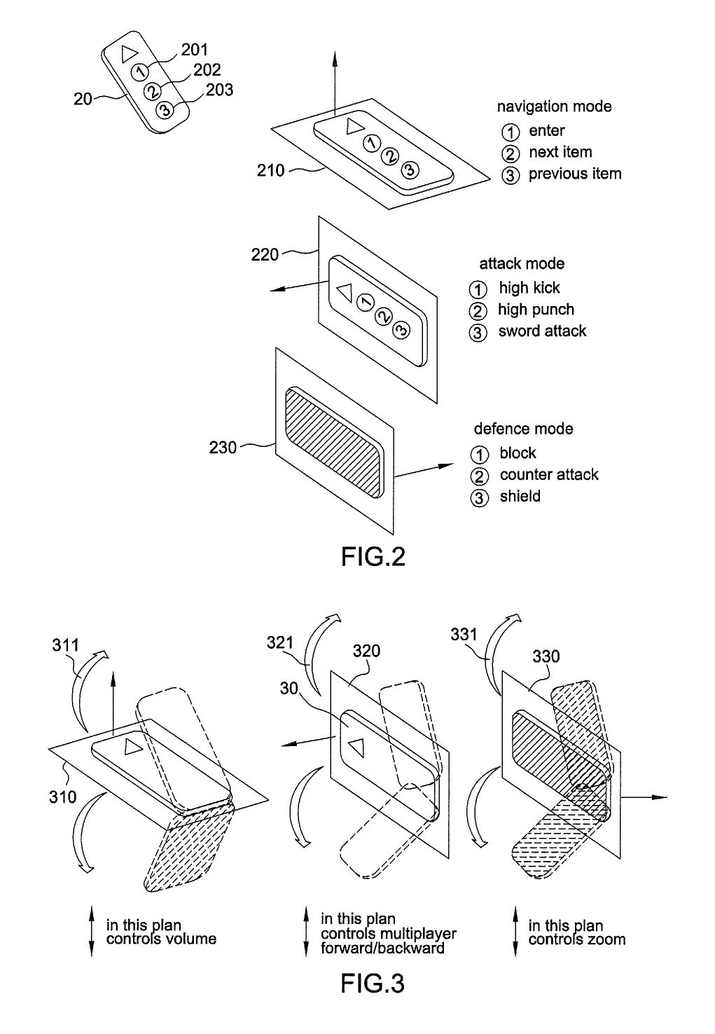

FIG. 2 represents an embodiment of the invention as a gaming interface;

FIG. 3 represents an embodiment of the invention as a remote control;

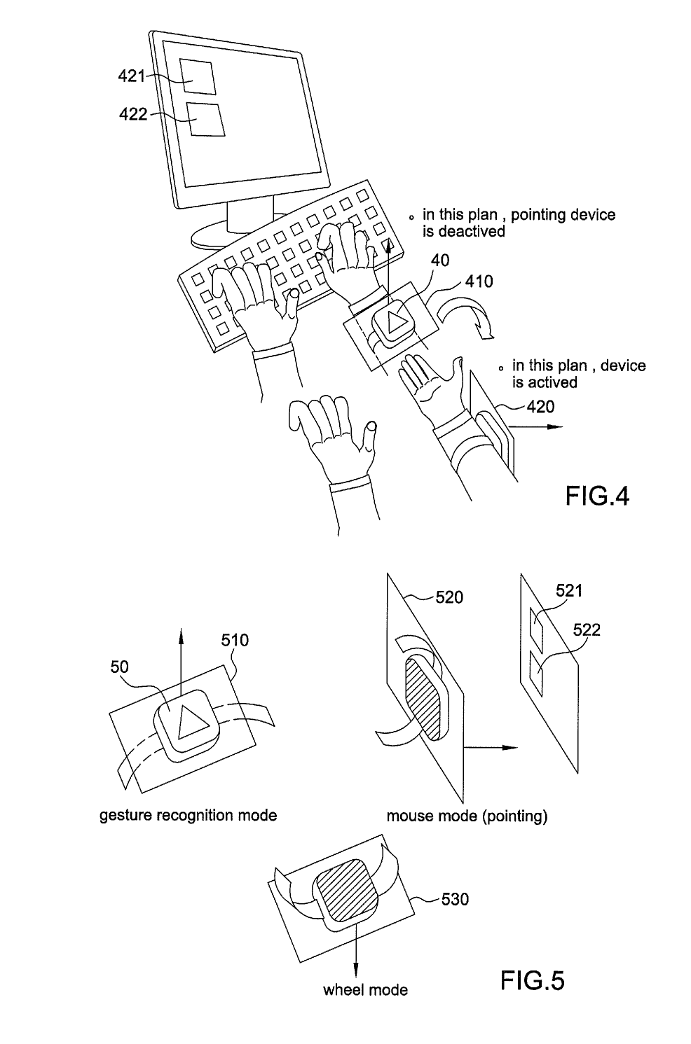

FIG. 4 represents an embodiment of the invention in combination with a keyboard;

FIG. 5 represents an embodiment of the invention as a 3D mouse with gesture recognition capacity.

FIG. 1a through 1d represent some interface devices of the prior art.

FIG. 1a represents a traditional mouse which can be moved in an X, Y horizontal plane which mirrors a display of a computer. It has a scroll wheel which is used to move the view of the elements which are displayed upwards and downwards. It also has two click buttons which are programmed to trigger the display of a list of actions which are context dependent when first clicked. The application generally allows to navigate through the list of displayed actions and to select one of them to be executed when the user presses a second time the click button. The user has to manipulate the mouse from a fixed position and the number of possible selections is limited to two lists for each context.
FIG. 1b represents a traditional Windows or Mac screen where menus or icons can be selected and scrolled to select an action in a list. Said selection can be performed either on a keyboard or using a mouse. The number of possible actions is multiplied by the number of graphical objects which can be selected. But the user still is limited in his capacity to move away from his seat. The user also has to learn and remember the position of the actions in a complex setting.
FIG. 1c represents a traditional remote control. It may have numerous buttons, some of which offering a navigation facility. Remote controls are normally used with a TV set. A remote control of the prior art gives more freedom to the user than a mouse: he can control the TV set while moving. But the graphical information which is made available to him is rather limited, as exemplified in FIG. 1d: when controlling the contrast of the display, this information only is accessible on the display. Also, the hierarchical structure of the menus accessible from a remote control is rather poor. This does not allow for fast navigation between branches of the programmed hierarchical structure.

An object of the invention is to provide a control device which allows easier navigation between multiple selections through different branches of a tree. Also, the device of the invention combines the capacity of a remote control to point at an appliance in the 3D space and to use the graphical capacities of a mouse-type interface. With such capacities, the device of the invention offers the potential of a universal graphical remote control fit, in various embodiments, for controlling applications on a PC, programmes on a TV set, games on a game console and various home appliances.

FIG. 2 represents an embodiment of the invention as a gaming interface. The device which is represented is an adaptation of an existing device such as an AirMouse™ by Movea™. An AirMouse comprises two sensors of the gyrometer type, each with a rotation axis. The gyrometers may be Epson™ XV3500. Their axes are orthogonal and deliver yaw (rotation angle around an axis which is parallel to the horizontal axis of a reference plane situated in front of the user of the AirMouse) and pitch (rotation angle around an axis parallel to the vertical axis of a reference plane situated in front of the user of the AirMouse). The rate of change in yaw and pitch as measured by the two gyrometers are transmitted by a radiofrequency protocol to a controller and converted by said controller, and adequate software present on the appliance to be controlled, in movements of a cursor on the display facing the user. The gyrometers may be arranged in the device casing to measure roll in lieu of yaw or pitch (Roll is the rotation angle of the device around an axis which is perpendicular to a reference plane situated in front of the user of the device). Other remote controls with an orientation sensing capacity may be used as the basis for implementing the invention.

In the example of FIG. 2, the AirMouse has been modified into a device 20 according to the invention, so that the gyrometers signals are used mainly to determine the orientation of the device in the air. In this example, three orientations only are used:
An orientation where the device is horizontal, with its top facing upward (orientation 210);
An orientation where the top of the device is facing leftward (orientation 220);
An orientation where the top of the device is facing rightward (orientation 230).

The number of orientations which may be selected as meaningful may be higher or lower. There is a limit to the number of meaningful orientations which depends upon the resolution of the sensors and their processing and upon the ability of the users to discriminate between different orientations. It may not be practical to exceed a number of 8 different orientations (a resolution of 45°) unless specific processing is added to classify the gestures of the users.

The device 20 has three buttons 201, 202, 203, each allowing selection of an action, the action which is triggered depending upon the orientation of the device. In the example of a combat game of FIG. 2, when the device is in orientation 210, the user will be able to use the Navigation mode and button 201 will trigger an “Enter” action, while buttons 202 and 203 will respectively trigger a “Next Item” action and a “Previous Item” action. When the device is in orientation 220, the user will be able to use the Attack mode and buttons 201, 202, 203 will respectively trigger a “High Kick” action, a “High Punch” action and a “Sword Attack” action. When the device is in orientation 230, the user will be able to use the Defence mode and buttons 201, 202, 203 will respectively trigger a “Block” action, a “Counter Attack” action and a “Shield” action. Therefore, with only three buttons, 9 actions may be controlled.

Starting from an AirMouse or an other like device, a man skilled in the art will be capable of adding an adequate number of buttons to fit with the specification of the definite application and to programme the controller and/or a driver in the appliance to be controlled so that the actual values of the roll orientation in selected bands will systematically trigger the change in mode specified by the designer of the application. Yaw or pitch may also be selected as the orientation to be measured/classified. Selection of the adequate orientation will depend upon the context of the application.

Of course, with more discrete orientations and more buttons, more actions may be controlled. For instance with 6 orientations and 6 buttons, 36 actions may be controlled. Therefore, we can generalise the example of FIG. 2 into a device according to the invention capable of controlling n×p actions with n discrete orientations and p buttons.

FIG. 3 represents an embodiment of the invention as a remote control 30 which may be used to control a TV set, a DVD or BRD set, an audio equipment, a home theatre or any appliance, simple or complex, with a number of functions which can take continuous values, such as volume, forward/backward read, zoom.

The starting point for building a remote control according to this invention may also be an AirMouse or a like device, while the buttons are not necessary. Device 30 as device 20 should have the capacity to discriminate between at least three roll orientations 310, 320, 330. In this example, these three orientations are the same as orientations 210, 220, 230 mentioned hereinabove. They are respectively assigned to the control of volume, forward/backward read and zoom. The actual control will be performed by the user by moving the device in the pitch plane. In other words, the value of the parameter defined by the roll orientation will be modulated by the value of the pitch. As a variant it is possible to envisage controlling discrete modes as well as continuous modes. A man skilled in the art will be capable of programming the controller and/or the appliance to be controlled so as to map the values of the parameters to be controlled, depending upon the roll orientation, to the pitch values.

It is possible to combine the embodiments of FIGS. 2 and 3 in a single device according to the invention. The resulting device will have a number of buttons to control sub modes of the principal mode selected based on the classified roll of the device. Then each sub mode having a continuous (or discrete) value will then be controlled by the pitch of the device.

FIG. 4 represents an embodiment of the invention in combination with a keyboard.

As represented by the figure, a user, working with a computer and using a keyboard for doing so, also wears a device 40 attached at his wrist looking like a watch. One such device is a MotionPod™ by Movea. A MotionPod comprises a three axes accelerometer and a three axes magnetometer, a pre processing module to condition signals from the sensors measurements, a radiofrequency transmit module to the processing module and a battery. Such motion capture sensor is a “3A3M” sensor (3 Accelerometers axes and 3 Magnetometers axes). The accelerometers and magnetometers are micro sensors which are commercially available. They have a small form factor, low power consumption and a low cost. Examples of such micro accelerometers matching this specification are marketed by Kionix™ (KXPA4 3628). Other such devices are available from STMT™, Freescale™ or Analog Device™. Likewise, examples of magnetometers for the MotionPod are marketed by HoneyWell™ (HMC1041Z for the vertical channel and HMC1042L for the 2 horizontal channels). Other such devices are available from Memsic™ or Asahi Kasei™. In a MotionPod, for the 6 signal channels, there is a combined filtering and, after analog to digital conversion (on 12 bits), the raw signals are transmitted to a base station (located on the appliance to be controlled or on a platform controlling more than one appliance) by a radiofrequency protocol operating in the Bluetooth™ band (2.4 GHz), said protocol being optimised to minimise power consumption. The transmitted raw data are then processed by a controller (which may process input from more than one device) to be then directed to application software. The sampling frequency can be adjusted. By default, it is set at 200 Hz. Higher values (up to 3000 Hz) may be contemplated when a high resolution is necessary, for instance to detect shocks.
Other devices may be used as the basis to build a device for this embodiment of the invention. Having two categories of sensors is helpful to improve reliability of the measurements, but the invention may be implemented with one type of sensor only.
A MotionPod may be used as a pointing device, for instance using a finger to determine the direction of pointing. As can be seen on FIG. 4, when the user types on the keyboard, device 40 remains substantially horizontal in orientation 410 and the pointing function of the device is not activated. Whenever the user wants to activate the pointing function, he just has to take his right hand off the keyboard and give it a 90° twist rightwards (in the example represented on the figure on to orientation 420). A man skilled in the art will be able to adapt the processing in the controller to discriminate between orientations 410 and 420 and trigger both corresponding modes. Keeping approximately the same orientation of his wrist, the user then can point at an area on the screen and use his finger as a mouse to select one of the (sub) options/(sub) modes represented by areas 421, 422 on the display of FIG. 4. A man skilled in the art knows how to calculate the position of a cursor on a display from the position and orientation in space of the pointing device calculated from the output of the sensors. Also, a user of the device can possibly use his fingers to generate one or more beats which will be interpreted as equivalent to a single/double right button/left button click of a traditional mouse. For doing so, a method disclosed in WO2008/060102 can be used. To implement said method, the processing of the MotionPod controller is adapted to include low pass-band filtering means of the accelerometers signals and compare the filtered signals to thresholds which are representative of the level of noise above which a variation of the signal will be considered as a beat.
Device 40 may be adapted to left-handed users: in this case, the most convenient twist to activate the pointing mode will be leftwards.

FIG. 5 represents an embodiment of the invention as a 3D mouse with gesture recognition capacity.

Device 50 represented on FIG. 5 can be seen as a variant of device 40 of FIG. 4. In this example, a MotionPod or a like device is adapted to have three modes corresponding respectively to orientations 510, 520 and 530: a gesture recognition mode, a pointing mode and a scroll mode. The pointing mode is identical to the one triggered by orientation 410 which has been described in connection with FIG. 4. There, the user may select one of the (sub) options/(sub) modes represented by areas 521, 522 on the display of FIG. 5. In the scroll mode which is triggered by orientation 530, the displayed page will be scrolled upward or downward, depending upon the direction of the scroll angle, from the point last pointed out before the change of mode. In the gesture recognition mode triggered by orientation 510 of the device, gesture recognition algorithms are implemented. Such algorithms include the use of hidden markov models, linear time warping or dynamic time warping, such as those described in <<Gesture Recognition Using The XWand>> (D. Wilson, Carnelie Mellon University, et A. Wilson, Microsoft Research, 2004). Gestures which are recognized may for example be letters (ie initials of an appliance or a function), figures (ie order of a function in a list of actions to be performed), etc . . . Gesture recognition may impose a learning mode, specifically when the system is multi user and when gestures reach a certain level of complexity.

It is also possible to combine the embodiments of the various figures in a manner wherein a user would carry a remote control 20, 30 in one hand (for example his right hand if he is right-handed) and wear on the wrist of his other hand, for example, a watch-like device 40, 50 comprising motion sensors. In a combined embodiment of this kind, the user will be able to control the selection of top level modes (gesture recognition, mouse, scroll, or an other set of modes) with the device 40, 50 activated by the motion of one of his hands and to operate selection of sub modes by orienting the remote control 20, 30 in an adequate manner in one of pitch, yaw or roll, then selecting options in these modes of a further level down by pushing the adequate button and/or orienting said remote control in one other of pitch, yaw or roll, as described hereinabove. This embodiment is advantageous because it increases the number of modes which can be accessed in a menu (n×p×q×r instead of n×p×q) and/or increases the capacity of the system with two devices to discriminate between modes.

The examples disclosed in this specification are only illustrative of some embodiments of the invention. They do not in any manner limit the scope of said invention which is defined by the appended claims.

1. Device for control by a user of at least one appliance comprising at least a sensor for capturing at least an orientation of said device, an interface to a processor, a mode selector for the user to select operating modes of one of said device and said appliance, an interface to at least a communication link to convey command signals to said appliance, wherein said processor converts said orientation into a first set of command signals representative of one of a first set of operating modes of one of said device and said appliance and said user is offered a selection among a second set of operating modes depending upon said one of said first set of operating modes, said selection generating a second set of command signals.

2. The device of claim 1, further comprising a module to point at a designated appliance and direct said command signals at said designated appliance.

3. The device of claim 2, wherein the pointing device points at a designated area on said designated appliance, said area comprising commands to be executed as a function of the command signals received from said device.

4. The device of claim 1, further comprising a module to capture beats and/or snaps from the user and generate an output to be combined with the first and second set of command signals.

5. The device of claim 1, further comprising a module to capture gestures from the user and generate an output to be combined with the first and second set of command signals.

6. The device of claim 1, wherein the first set of command signals defines n modes, each of the n modes having a number of sub modes which are controlled by the second set of command signals.

7. The device of claim 6, wherein one of yaw, pitch and roll of the device is classified into n discrete modes and the mode selector is made of p buttons, said device being then capable of controlling n×p modes of one or more appliances.

8. The device of claim 1, wherein a first subset of the first set of command signals corresponding to one of roll, pitch and yaw of the device and defines q modes, and a second subset of said first set of command signals corresponding to an other of roll, pitch and yaw of the device defines a value of each mode q.

9. The device of claim 1, wherein the output of the orientation sensor defines an operating mode of the device.

10. The device of claim 9, wherein the operating modes of the device comprise at least a gesture recognition mode, a pointing mode and a scroll mode.

11. The device of claim 10, wherein the mode selector activates/deactivates a keyboard and the orientation sensor is worn on one wrist of one hand of the user.

12. The device of claim 11, wherein the pointing function of the orientation sensor is deactivated as long as the hand of the user wearing said sensor stays in a first orientation fit for typing on the keyboard and is activated as long as said hand stays in a second orientation different from the first orientation.

13. System for control by a user of at least one appliance, the system comprising:
a first device comprising:
a sensor for capturing at least an orientation of said device;
an interface to a processor;
a mode selector for the user to select operating modes of one of said device and said appliance;
an interface to at least a communication link to convey command signals to said appliance; and
a module to point at a designated appliance and direct said command signals at said designated appliance,
wherein:
said processor converts said orientation into a first set of command signals representative of one of a first set of operating modes of one of said device and said appliance and said user is offered a selection among a second set of operating modes depending upon said one of said first set of operating modes, said selection generating a second set of command signals; and
said first device defines a number of first options for controlling said appliance;
a second device comprising:
a sensor for capturing at least an orientation of said device;
an interface to a processor;
a mode selector for the user to select operating modes of one of said device and said appliance; and
an interface to at least a communication link to convey command signals to said appliance,
wherein:
said processor converts said orientation into a first set of command signals representative of one of a first set of operating modes of one of said device and said appliance and said user is offered a selection among a second set of operating modes depending upon said one of said first set of operating modes, said selection generating a second set of command signals;
the output of the orientation sensor defines an operating mode of the device; and
said second device defines a number of second options as sub options of the first options.

14. Method for control by a user of at least one appliance comprising at least a step for capturing by a motion sensor encased in a device borne by said user at least an orientation of said device, a step of interface to a processor, a step of using a mode selector for the user to select operating modes of one of said device and said appliance, a step of interface to at least a communication link to convey command signals to said appliance, wherein said processor converts said orientation into a first set of command signals representative of one of a first set of operating modes of one of said device and said appliance and said user is offered a selection among a second set of operating modes depending upon said one of said first set of operating modes, said selection generating a second set of command signals.

15. Method according to claim 14, further comprising a step of capturing orientation of a second device, said orientation of a second device being combined with said second set of command signals to generate a third set of command signals.
